(19) United States
(12) Patent Application Publication
(10) Pub. No.: US 2008/0179305 A1
(43) Pub. Date: Jul. 31, 2008

(54) Torque arm assembly

(76) Inventors: Haimian Cai, Ann Arbor, MI (US); William R. Koivula, Milford, MI (US); Baoluo Chen, Rochester Hills, MI (US)

Correspondence Address: AUTOMOTIVE COMPONENTS HOLDINGS LLC;C/O MACMILLAN, SOBANSKI & TODD, LLC, ONE MARITIME PLAZA, FIFTH FLOOR, 720 WATER STREET, TOLEDO, OH, 43604-1853, US

(21) Appl. No.: 11/699,645

(22) Filed: Jan. 30, 2007

(51) Int. Cl. B23K 9/24

(52) U.S. Cl. 219/137.2

(57) ABSTRACT

A method of manufacturing a torque arm assembly for use in an automotive vehicle utilizing a cold hybrid MIG technique to minimize the introduction of excessive heat into the welded sheet metal panel components of the assembly. Outer and inner metal panels of the assembly are formed with edges along their lengths and are mated with their overlapping edges forming a joint that is welded. The cold hybrid MIG technique involves moving the weld gun so that its weld wire tip is in contact with the outer surface of the inner panel. Applying electrical energy between the weld wire and the panel for a period of time that is sufficient to cause the tip of the weld wire to become a molten drop. Terminating the application of electrical energy and moving the weld wire away from contact to allow the molten wire drop to enter the joint and form the weld. Repeating the weld steps at a high frequency at each point along the joint to is complete the weld along its length. Spacers between the panels are also tack welded onto the inner surface of one of the panels utilizing the same cold hybrid MIG technique.

### BACKGROUND OF THE INVENTION

The invention relates generally to the field of automotive component manufacture and more specifically to a method of welding the components that make up a torque arm assembly for an automotive vehicle.

A torque arm is normally used in an automotive suspension system for stabilizing and maintaining the geometry of the rear end of such system under cornering loads, while allowing the driveshaft and other components to function as intended. Typically, a torque arm is an assembly that is constructed of two preformed panels of sheet metal. The metal panels are mated together and welded along overlapping joints formed along their lengths. The assembly also includes metal spacer elements tack welded within and between the mated panels to provide cylindrical passages co-axial with pre-formed and opposing bolt-through holes in the metal panels and separating support for the panels.

In a conventional manufacturing process for such torque arm assemblies, the spacers are tack welded to one of the panels and the mated preformed metal panels are welded together using traditional MIG or TIG welding methods. Several problems have been persistent in using such welding methods and have been difficult to overcome. Primarily, conventional MIG or TIG welding methods generate excessive heat on the metal. When used to tack weld the spacers in place, dimpled distortions are often created which appear on the external surface of the panel. Such distortions in appearance may be a sign of induced weakness in the panel structure. These welding methods also can cause other distortions. When welding the lap joint between the panels, these welding methods tend to cause an excessive amount of heat to be introduced into the weld area and cause spattering of the molten material onto the work piece and surrounding area. Spattering provides a sloppy appearance to the work piece which requires additional steps to clean the part for quality acceptance. Additionally, the high heat generated by these welding methods at the lap joint can cause distortion of the metal panels that, in some cases, is sufficient to cause the un-welded gap between metal panel and one or more of the respective spacers to be out of tolerance.

### SUMMARY OF THE INVENTION

The present invention is directed to a method of welding a torque arm assembly utilizing a spatter-free and relatively cold hybrid MIG welding process to tack weld spacers in place and to weld lap joints created between mated metal panels.

The technique described herein utilizes a cold hybrid MIG welding process. It involves controlling the voltage, current and wire movement in a precise manner to achieve a solid weld between adjacent metal surfaces, without spattering and with reduced heat distortion of the sheet metal. Such results are advantageous from the standpoint of eliminating the requirement of removing spattering residue and a lower rejection rate due to dimpling. Additionally, this cold hybrid MIG welding process has been found to cause much less heat to be generated in the affected weld zone and therefore allows for more consistent dimensional control of the work pieces. Another advantage is a reduction in energy costs for the welding process due to the fact that it is not a continuous weld, but rather a series of pulsed or intermittently generated welds, generally at lower voltage and/or amperage.

It is an object of the present invention to provide an improved method of manufacturing a torque arm assembly of preformed sheet metal panels by utilizing a cold hybrid MIG welding process to achieve high quality results.

This object is achieved on a torque arm assembly that includes an outer metal panel and an inner metal panel, the outer metal panel is formed to have upward extending edges along its length and the inner metal panel is formed to have downwardly extending edges along its length. The inner metal panel has width dimensions that are slightly less than the corresponding width dimensions of the outer metal panel. The outer metal panel and the inner metal panel are mated together along their upward and downward extending edges so that a narrow gap or joint is formed between the inner surface of each of the upward extending edges and the corresponding portion of the opposing outer surface of the inner metal panel. The method further includes the steps of utilizing a cold hybrid MIG welding process by control moving the end tip of the sacrificial weld wire to contact the outer surface of the inner metal panel adjacent the gap; applying a predetermined value of electrical energy between the wire and the metal panel for a predetermined amount of time to cause conduction therebetween and the end of the wire to become molten; upon terminating the application of electrical energy, pulling back the weld wire tip to break contact with the panel and allowing the molten drop to enter the gap and form a weld. The steps of contacting, applying and terminating electrical energy, and pulling back are repeated at pre-selected points along the gap until each gap is filled and welded along its length.

It is another object of the present invention to provide a method of manufacturing the elements of a torque arm assembly by attaching spacer elements to the inside surface of one of the metal panels utilizing a cold hybrid MIG welding process to achieve high quality results.

That object is achieved in a method that includes placing at least one metal spacer element at a predetermined location on the inner surface of one of the panels prior to welding the panels. The method further includes the steps of utilizing a cold hybrid MIG welding process by touching the end tip of the sacrificial weld wire of the weld gun to the joint formed at the point of contact between the spacer and the inner surface of the metal panel; applying a predetermined value of electrical energy between the wire and the joint to cause conduction therebetween and allowing the end of the wire to become molten. After a predetermined period of time, the application of electrical energy is terminated and the weld wire tip is pulled back to break contact with the joint. The molten drop falls onto the joint and forms a tack weld between the spacer and the panel. Of course, the steps of touching, energizing and pulling back at pre-selected points along the joint can be repeated if it is desirable to tack weld the spacer at additional points around the joint.

Applying the cold hybrid MI weld process to the tack welding of spacers also allows the manufacturer to utilize dissimilar materials for the panel and the spacer, and therefore allows one to design for the optimization of strength or weight improvements.

### BRIEF DESCRIPTION OF THE DRAWINGS

FIG. 1 is a perspective view of a torque arm assembly.

FIG. 2 is an exploded view of the torque arm assembly shown in FIG. 1.

FIG. 3 is a cross-sectional view of a portion the torque arm assembly shown in FIG. 1 containing a spacer element.

FIG. 4 is a wave diagram illustrating the periodic application of electrical energy to the weld tip used in the welding process.

FIGS. 5A-5C illustrate the welding process utilized in manufacturing a torque arm assembly.

### DETAILED DESCRIPTION OF THE INVENTION

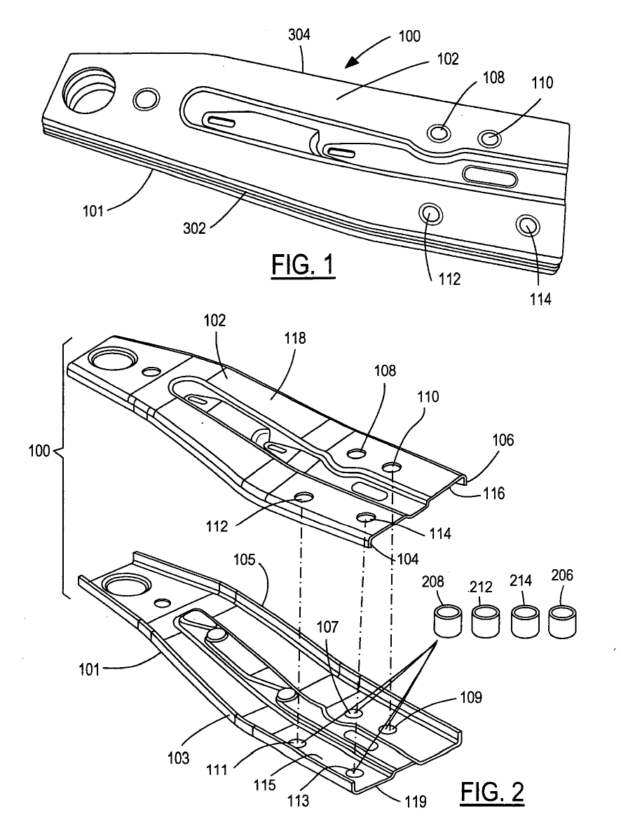

The torque arm assembly of the present invention is shown in FIGS. 1, 2 and 3. The torque arm assembly 100 includes a preformed sheet metal outer panel 101 and a preformed sheet metal inner panel 102. Outer panel 101 has edges 103 and 105 formed along its length to extend in an upward direction and define an inner surface 115 and an outer surface 119. Inner panel 102 has edges 104 and 106 formed along its length to extend in a downward direction and define an inner surface 116 and outer surface 118. Panels 101 and 102 are formed with dimensions that facilitate mating in a manner as shown in FIG. 1. The outer width dimensions of the inner panel 102 are slightly less than the corresponding inner width dimensions of the outer panel 101. The differences in those width dimensions define gap joints 302 and 304 on opposite sides of the assembly when the panels are mated. Each of these gap joints must be welded along their respective lengths.

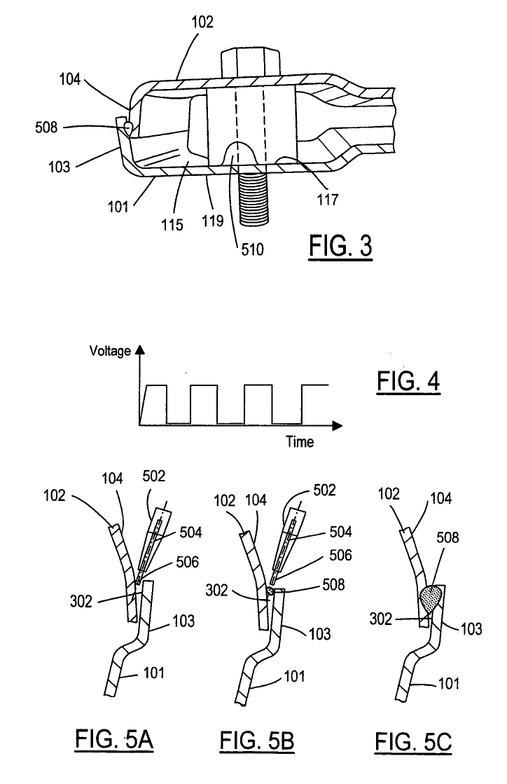

Assembly 100 also includes at least one spacer for each through-bolt location. In this case, four such spacers 206, 208, 212 and 214 and are provided in alignment with opposing though-holes 107-108, 109-110, 111-112 and 113-114, respectively. The spacers are hollow metal cylinders and function to maintain the desired thickness of the torque arm assembly and prevent distortion when the through-bolts are tightened. In order to hold the spacers in place throughout the manufacturing process of the torque arm and thereafter, the spacers must be welded to one of the panels. In FIG. 3, one of the spacers (exemplified as spacer 214 in FIG. 3) is shown as welded 510 to inner surface 115 of outer panel 101 at a corner joint 117 formed between the lower end of the spacer and surface 115.

The cold hybrid MIG welding method utilized in this invention is described in conjunction with FIGS. 4 and 5A-5C. A modified MIG type welding apparatus is provided with a controllable and movable weld gun 502 and that includes a sacrificial weld wire 504 that is controllably advanced and retracted from a supply spool (not shown). Although not shown, the inert gas utilized in a conventional MIG welder is used in this method also to saturate and protect the weld zone.

One step of the weld method, represented in FIG. 5A, is to move weld gun 502 to a location where the weld wire 504 is advanced and the end tip 506 is placed into contact with outer surface 104 of inner panel 102, adjacent gap 302.

Another step in the weld method, represented in FIG. 5B, is to apply a predetermined amount of electrical energy to wire 504 for a period that corresponds to a single applied voltage step represented in the waveform of FIG. 4. During that period of energy application, tip 506 of weld wire 504 is instantaneously heated to a molten state and becomes attracted to a correspondingly heated spot on surface 104 in gap 302.

A subsequent step in the weld method is for the application of voltage to be terminated and weld wire 504 to be pulled back or drawn into the gun 502. As is represented in FIG. 5, this allows molten material 508 to be drawn into gap 302 and create the weld joint between panels 101 and 102. At this time during the duty cycle, when the energy is off, no heat is being added to the work piece. In order to produce a completely welded joint over the length of each gap, the steps of contacting, applying and terminating electrical energy, and pulling back are repeated at pre-selected points along the gaps.

The period of energy application (i.e., on time of the duty cycle) is determined according to several factors including the material used for the weld wire, the material being welded, as well as the voltage and current produced during the period. Once it is set, it can be repeated for each weld that occurs during each duty cycle (i.e., the period defined by the time between each applied energy step). In this embodiment, it has been found that duty cycles having a 60 HZ repetition rate are desirable, but may be increased as improvements in equipment are made.

During the step in which tip 506 is being placed in contact with surface 104 adjacent gap 302, a downward force can be exerted on the tip. This results in a favorable lateral force on the welding tip.

The same series of steps, as stated above with respect to FIGS. 5A-5C, are used to tack weld the spacers onto inner surface 115 of outer panel 101 at joint 117 formed between the bottom of spacer 214 and surface 115. Additionally, it is advisable to temporarily clamp or otherwise hold the spacer element in place during at least the first tack weld to make sure it remains precisely located. In this embodiment, it has been found sufficient to tack weld the spacer at several points along joint 117, rather than making a continuous weld. As such, the steps of the duty cycle shown in FIG. 4 will be at a lower frequency to accommodate greater movement of weld gun 502 between welds.

It should be understood that the foregoing description of the embodiments is merely illustrative of many possible implementations of the present invention and is not intended to be exhaustive.

We claim:

1. A method of welding a torque arm assembly comprising an outer metal panel and an inner metal panel;
said outer metal panel being formed to have upward extending edges along its length;
said inner metal panel being formed to have a downwardly extending edges along its length;
said inner metal panel having width dimensions that are slightly less than corresponding width dimensions of said outer metal panel;
said outer metal panel and said inner metal panel being mated together along said upward and downward extending edges to define an overlap joint between the inner surface of said upward extending edge and the outer surface of said inner metal panel;
utilizing a cold hybrid MIG welding process by moving the sacrificial wire weld tip of a weld gun into contact with the outer surface of said inner metal panel adjacent said joint; applying a predetermined amount of electrical energy between said wire weld tip and said inner panel for a predetermined amount of time to create a molten drop of wire at said tip; terminating the application of electrical energy; pulling back said weld wire tip to break said contact with said panel and allow said molten drop to enter into said joint and form said weld;
repeating said steps of contacting, applying and terminating electrical energy and pulling back said gun at pre-selected points along said joint until said joint is welded along its entire length.

2. The method of claim 1 wherein said step of contacting includes the step of causing a downward force to be applied to said weld wire sufficient to cause forces to be generated in said wire that will direct said molten wire towards said joint.

3. The method of claim 1 wherein, prior to said step of contacting, said weld wire in said gun is controlled to be advanced a predetermined amount that corresponds to the amount of wire used in the immediately previous weld.

4. The method of claim 1 wherein said step of pulling back includes the step of drawing the wire back into the weld gun by a predetermined amount.

5. The method of claim 1 wherein said welds are performed at a predetermined and periodic rate.

6. The method of claim 4 wherein said rate is in the rang of approximately 1-100 Hz.

7. A method of welding a torque arm assembly comprising an outer metal panel and an inner metal panel;
forming upwardly extending edges along the length of said outer metal panel;
forming downwardly extending edges along the length of said inner metal panel;
said inner metal panel being formed to have width dimensions that are slightly less than corresponding width dimensions of said outer metal panel;
mating said outer metal panel and said inner metal panel together at said respective upwardly and downwardly extending edges to provide a narrow gap between the outer surface of said downwardly extending edges of said inner metal panel and the inner surface of said upward extending edges of said outer metal panel;
welding said metal panels together utilizing a modified MIG welding process by locating the weld wire tip of a weld gun in a position to contact said outer surface of said inner metal panel adjacent said gap;
electrically energizing said weld tip for a predetermined period of time to create a molten drop of wire from said tip;
pulling back said weld wire tip to break contact with said panel and allow said molten drop to fall into said gap and form a weld;
repeating said steps of contacting, energizing and pulling back at pre-selected points along said gap until said gap is welded along its entire length.

8. The method of claim 7 wherein said step of contacting includes the step of causing a downward force to be applied to said weld wire sufficient to cause forces to be generated in said wire that will direct said molten wire towards said gap.

9. The method of claim 7 wherein said torque arm further includes at least one metal spacer element that is located at a predetermined point between said inner and outer metal panels and wherein said method includes the steps of:
placing said metal spacer at its predetermined location on the inner surface of one of said panels prior to welding said panels;
welding said placed spacer to said inner surface of said panel utilizing a cold hybrid MIG welding process by moving the weld wire tip of weld gun to touch the joint formed between said placed spacer and said inner surface of said metal panel;
electrically exciting said weld tip to create a molten drop of wire at said tip;
pulling back said tip to break contact with said joint and allow said molten drop to fall onto said joint and form a weld;
repeating said steps of contacting, exciting and pulling back at pre-selected points along said joint until said spacer is welded to said panel.

10. The method of claim 9 wherein said spacer is temporarily held in place during said steps of welding to prevent undesired movement from said predetermined location.
